(19) United States
(12) Patent Application Publication
(10) Pub. No.: US 2006/0279763 A1
(43) Pub. Date: Dec. 14, 2006

(54) Image copying device, image copying system, and image copying method

(75) Inventors: Tomonobu Tamura, Toyokawa-shi (JP); Akihiro Hayashi, Okazaki-shi (JP); Tatsuya Eguchi, Toyohashi-shi (JP); Hiroyuki Yoshikawa, Hoi-gun (JP); Kenichi Hayashi, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/360,701

(22) Filed: Feb. 24, 2006

(30) Foreign Application Priority Data
Jun. 13, 2005 (JP) 2005-172653

(51) Int. Cl. G06K 15/00; G06F 15/00

(52) U.S. Cl. 358/1.14; 358/474

(57) ABSTRACT

An image copying device and an image copying system are arranged to read an image of a document and to acquire copyright information on each area regarding the image of the document from an IC chip embedded in the document. Then, based on the read image data and the acquired copyright information, a selection screen is displayed on a manipulation/display panel. Copyright information on each area of the image of the document is schematically represented on the selection screen. Whether or not copying is performed is selected area by area by manipulation by a user on this screen. For areas for which “copying” is selected is copied, but areas for which “nocopying” has been selected is not copied. Further, a copyright fee pertaining to the copied areas is collected. Thus, the image copying device and an image copying system enable the user to select appropriate processing according to differences in copyright information from one area to another of the image and cause images to be formed.

### CROSS-REFERENCE TO RELATED APPLICATIONS

This application is based upon and claims the benefit of priority from the prior Japanese Patent Application No. 2005-172653 filed on Jun. 13, 2005, the entire contents of which are incorporated herein by reference.

### BACKGROUND OF THE INVENTION

1. Field of the Invention

The present invention relates to an image copying device for forming an image reproduced from the image of a document on a medium and an image copying system utilizing it, and an image copying method which will be implemented using the image copying system with the image copying device. More particularly, it relates to an image copying device which is enabled to properly cope with restriction on reproduction imposed on the image of the document under a copyright or any other intellectual property right and an image copying system utilizing it, and an image copying method which will be implemented using the image copying system with the image copying device.

2. Description of the Related Art

Pictures to be processed by an image formation device include some to which an exclusive right such as a copyright (hereinafter to be referred as simply “copyright”). Because of this circumstance, techniques by which images are formed while properly conforming to the copyrights involved have been proposed. For instance, a network system disclosed in Japanese Unexamined Patent Publication No. 9-18720 (1997) encrypts image data read from a page in a book form with a reader, and stores the encrypted data in an information processing device. The encrypted image data can never be reproduced without a dedicated LSI and program for decrypting.

A digital copying machine according to Japanese Unexamined Patent Publication No. 2000-224406 is arranged to recognize watermark information embedded into image data. If the recognized watermark information includes a fee for copyright, that copyright fee will be displayed on a display unit. Or if the watermark information includes a copyright ID, the copyright managing server will be inquired of the copyright fee matching that ID and the copyright fee will be displayed on the display unit. In this way, the copyright fee is collected by a copy vender.

### SUMMARY OF THE INVENTION

However, in either cases of the related art described above, if the image to be copied involves a part protected by a copyright, the whole image will be treated as a copyrighted work (which means a work protected by a copyright; the same applies hereinafter). However, actually it is not rare only a specific part, such as a photograph, of the image is a copyrighted work. But, it is impossible by either of these methods to properly process each individual part of the image according to whether it is copyrighted or not. For instance, even if it is desired to print only the part free from the copyright, it is impossible. Especially by the technique according to Japanese Unexamined Patent Publication No. 9-18720(1997), any single image consisting of stored image data can be even looked at unless the full sum of the copyright fee set for the image is paid.

The present invention has been attempted with a view to solving the above-noted problems involved in the related art. Thus, the object of the invention is to provide an image copying device which enables a user to make a proper selection according to differences in copyright information among individual areas of an image and can form an image according to that user's selection and an image copying system utilizing it, and an image copying method which will be implemented using the image copying system with the image copying device.

To achieve the purpose of the invention, there is provided an image copying device for copying an image of a document, comprising: a scanner for acquiring image data by scanning the document, a reproduction constraint information acquiring unit for acquiring reproduction constraint information on the image of each area of the document, a selection accepting unit for accepting selection by a user regarding whether or not copying is performed with respect to each area of the document within an extent permitted by the acquired reproduction constraint information, and a copying unit for copying image pertaining to the area selected to be copied by the selection accepting unit based on the image data acquired by the scanner.

The image copying device according to the invention scans the subject copy with the scanner to make a reproduction of the document, and acquires the image data of the document. Along with that, it acquires image reproduction constraint information on the document on an area-by-area basis with the reproduction constraint information acquiring unit. Then the selection accepting unit-accepts selection by the user as to whether or not copying is required of each individual area within the extent permitted by the reproduction constraint information. In accordance with the accepted selection, a copying unit copies each area of the image which the selection accepting unit has accepted the selection for copying. In this way, the use of this image copying device enables its user to make a selection by his or her own will as to whether or not to copy each individual area of a document, for which reproduction constraint is set on an area-by-area basis, within the extent permitted by reproduction constraint information.

Furthermore, according to another aspect of the present invention, there is provided an image copying system comprising an image copying device for copying an image of a document and a reproduction constraint information server in which reproduction constraint information on images is accumulated, wherein the image copying device further comprises: a scanner for acquiring image data by scanning the document, a reproduction constraint information acquiring unit for acquiring reproduction constraint information on the image of each area of the document from the reproduction constraint information server, a selection accepting unit for accepting selection by a user regarding whether or not copying is performed with respect to each area of the document within an extent permitted by the acquired reproduction constraint information, and a copying unit for copying image pertaining to the area selected to be copied by the selection accepting unit based on the image data acquired by the scanner.

The invention also provides an image copying system further comprising a fee charging device for collecting copying fees, and in addition the image copying device provided with a fee charging information transmitting unit which transmits information on copying fees to the reproduction constraint information server when the image copying device executes copying.

According to another aspect of the invention, furthermore, there is provided an image copying method for copying an image of a document, comprising the steps of: acquiring image data by scanning the document with a scanner, acquiring reproduction constraint information on the image of each area of the document with a reproduction constraint information acquiring unit, accepting selection by a user regarding whether or not copying is performed with respect to each area of the document within an extent permitted by the acquired reproduction constraint information, and copying image pertaining to the area selected to be copied by the selection accepting step with a copying unit based on the image data acquired by the scanner.

According to the invention, there is provided image copying device enabling the user to make a proper selection according to differences in copyright information among individual areas of an image and capable of forming an image according to that user's selection, an image copying system utilizing it, and an image copying method which will be implemented using the image copying system with the image copying device.

### BRIEF DESCRIPTION OF THE DRAWINGS

FIG. 1 is a block diagram of an image copying system in the present embodiment;

FIG. 2 shows a front view of a multifunctional copying machine in the present embodiment;

FIG. 3 is a block diagram showing a control system of the multifunctional copying machine in the present embodiment;

FIG. 4 is a perspective drawing of a scanner of the multifunctional copying machine in the present embodiment;

FIG. 5 shows an example of image of a subject copy in which copyrighted areas are set in a first case of processing;

FIG. 6 shows a state in which copyright information on the subject copy is displayed on a display panel in the first case of processing;

FIG. 7 shows an example of copied output in the first case of processing;

FIG. 8 shows another example of copied output in the first case of processing;

FIG. 9 shows still another example of copied output in the first case of processing;

FIG. 10 is a flow chart (Part 1) illustrating the procedure of processing in the first case of processing;

FIG. 11 is a flow chart (Part 2) illustrating the procedure of processing in the first case of processing;

FIG. 12 shows an example of image of a subject copy in which copyrighted areas are set in a second case of processing;

FIG. 13 shows a state in which copyright information on the subject copy is displayed on a display panel in the second case of processing;

FIG. 14 shows a state in which an alarm screen against image overlapping is displayed on a display panel in a third case of processing;

FIG. 15 is a flow chart illustrating part of the procedure of processing in the third case of processing;

FIG. 16 shows a state in which an output pattern is displayed on a display panel in a fourth case of processing; and

FIG. 17 is a flow chart illustrating part of the procedure of processing in the fourth case of processing.

### DETAILED DESCRIPTION OF THE PREFERRED EMBODIMENTS

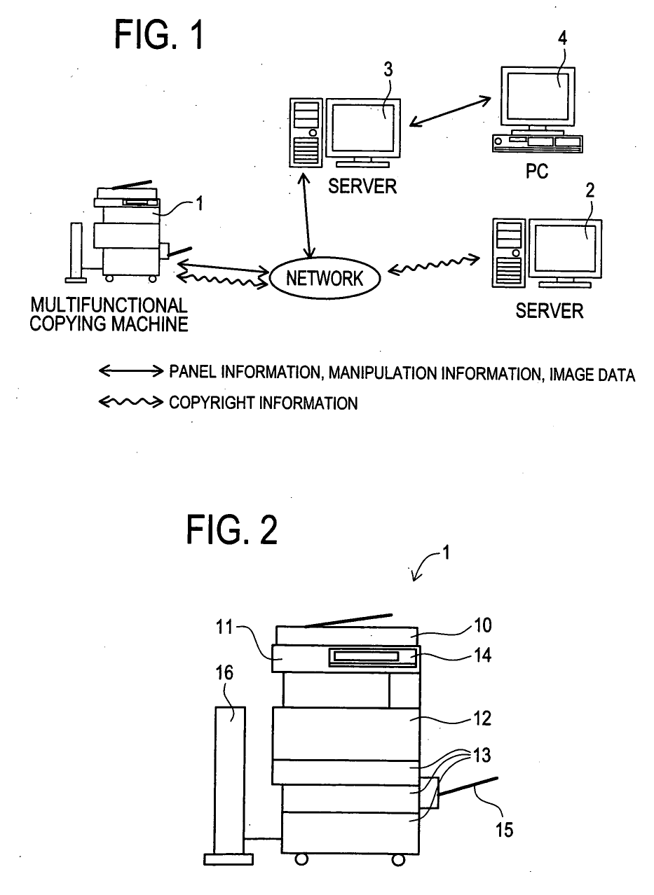

Preferred embodiments of the present invention will be described in detail below with reference to the accompanying drawings. An image formation system, which is a preferred embodiment of the invention, is configured as shown in FIG. 1. This image formation system (hereinafter to be referred to as simply “this system”) enables mutual communication to be accomplished among a multifunctional copying machine 1, a copyright information server 2 and a server 3 via a network. A personal computer (PC) 4 is further connected to the server 3.

The multifunctional copying machine 1 is the central element of this system. The multifunctional copying machine 1 is a multifunctional machine equipped with, in addition to the copying function to print the image of a document onto printing paper, a function to externally transmit image data acquired from the document, a function to print image data received from outside and so forth. Thus, “copying” by the multifunctional copying machine 1 is accomplished in one of two ways, including hard copying by printing and data copying by data transmission. It is further equipped with a function to acquire copyright information on the image of the document and performs proper processing on that basis. The copyright information server 2 is a server in which copyright information on various images is stored. Details of these units will be described afterwards. The server 3 and the PC 4 are conventional ones.

Among the elements of this system shown in FIG. 1, the multifunctional copying machine 1, the server 3 and the PC 4 constitute a so-called local network. The copyright information server 2 is accessed via an external network. It has to be noted, though, that other configurations, such as one in which the server 3 and the PC 4 are accessed via an external network or another in which the copyright information server 2 constitutes part of a local network, are also possible. Incidentally in this system shown in FIG. 1, information concerning copyright is mainly exchanged between the multifunctional copying machine 1 and the copyright information server 2. On the other hand, among the multifunctional copying machine 1, the server 3 and the PC 4, information concerning panel displaying, information regarding the manipulation of the multifunctional copying machine 1, image data and the like are exchanged.

The multifunctional copying machine 1, whose external view is shown in FIG. 2, has an automatic document feeding device 10 in its top part. It further has downward from underneath the device 10, a scanner 11, a printer 12 and a paper feed unit 13. On the front face of the scanner 11 part, a manipulation/display panel 14 is disposed, and beside the paper feed unit 13 a manual feed tray 15 is disposed. The manipulation/display panel 14 not only displays information but also accepts manipulations including the selection of an area. The top face of the printer 12 also serves as a paper discharge tray. A coin dispenser 16 is also fitted to the multifunctional copying machine 1. Functions of the coin dispenser 16 may as well be built into the multifunctional copying machine 1.

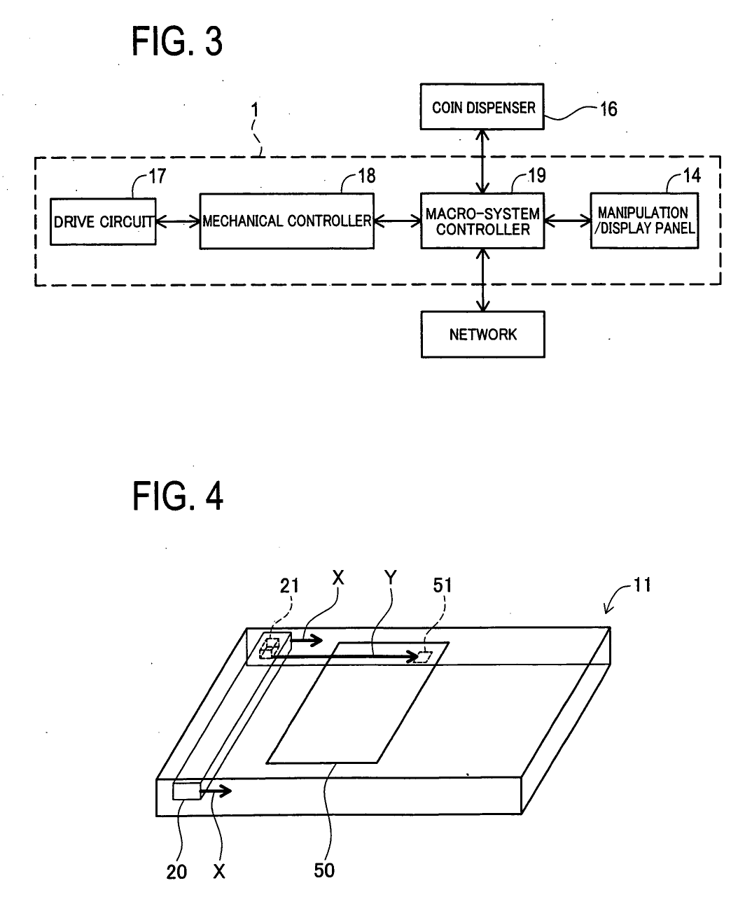

The control system of the multifunctional copying machine 1 is configured as shown in FIG. 3. The multifunctional copying machine 1 shown in FIG. 3 is provided with, in addition to the manipulation/display panel 14, a drive circuit 17, a mechanical controller 18 and a macro-system controller 19. The drive circuit 17 is a circuit for driving the mechanical parts of the automatic document feeding device 10, the scanner 11, the printer 12 and the paper feed unit 13. The mechanical controller 18 is intended for control of the drive circuit 17. The macro-system controller 19 is responsible for other control than mechanical control in the multifunctional copying machine 1. More specifically, besides handling image data and copyright information, it controls the manipulation/display panel 14, communicates with the coin dispenser 16 and performs transmission and reception to and from outside via a network.

The scanner 11 of the multifunctional copying machine 1 is provided with a slider 20 as shown in FIG. 4. The slider 20 is intended in stationary reading to move as indicated by arrow X to pick up the image of a document 50. The slider 20 in the present embodiment also has a function to communicate with an IC chip 51 embedded in the document 50. For this purpose, an antenna 21 is built in the slider 20. The antenna 21 moves as indicated by arrow Y along with the movement of the slider 20 to pass over the IC chip 51 embedded in the document 50. Accordingly, if the document 50 has an embedded IC chip 51 built in it, the antenna 21 can extract necessary information from the IC chip 51. The image data acquired by the slider 20 and the data acquired by the antenna 21 from the IC chip 51 are entered into the macro-system controller 19 in the control system shown in FIG. 3, and made available for use in various ways of processing including image formation. The printer 12 and the paper feed unit 13 other than the scanner 11 have no particular differences from their respective usual counterparts.

The basic functions of the multifunctional copying machine 1 include printing of the image of the document 50, transmission of image data read from the document 50 to the PC 4 or the like, and printing of the image data received from the PC 4. Further, in reading the image of the document 50 with the scanner 11, it also acquires information from the IC chip 51 embedded in the document 50 as described above. It thereby performs processing based on copyright information set for the image of the document 50. Incidentally, the multifunctional copying machine 1 can as well be manipulated from the server 3 or the PC 4. In that case, the same contents as those in the screen displayed on the manipulation/display panel 14 of the multifunctional copying machine 1 are displayed on the display unit of the server 3 or the PC 4.

[First Case of Processing]

As a first case of processing by the multifunctional copying machine 1, a case in which copyright information is set for each area of the image of the document 50 and whether or not to copy is selected area by area will be described.

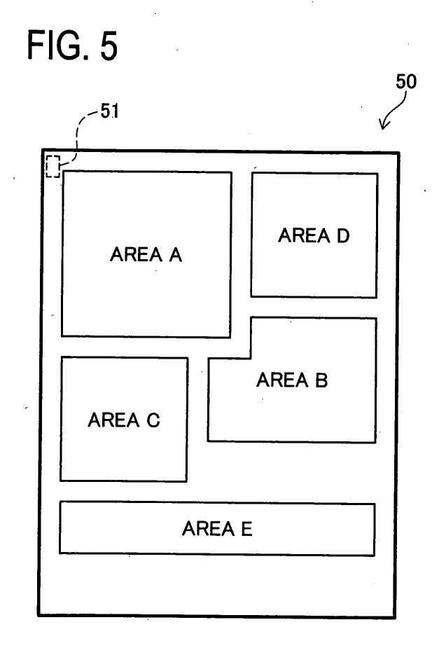

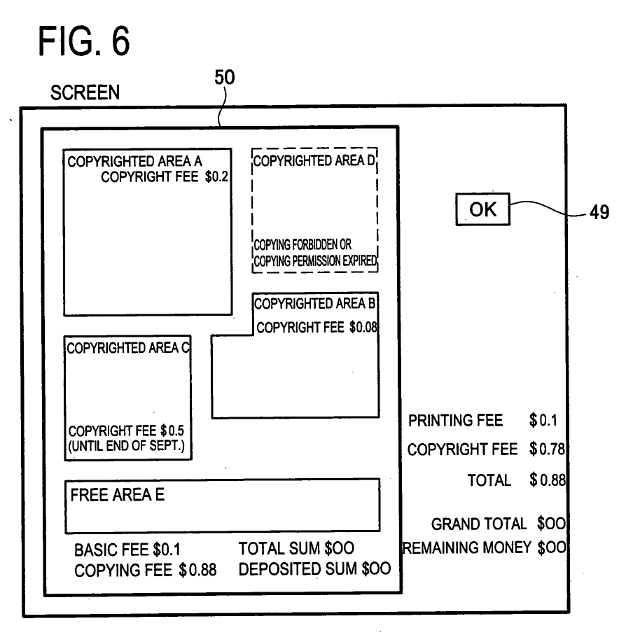

It is supposed, for instance, that the image of the document 50 is such as shown in FIG. 5. In the example of FIG. 5, there are areas A to E in a page. In an actual case, the content of each area may be a photograph, a picture or a literal description. Then, copyright information is acquired from the IC chip 51. The acquired copyright information may be, for instance, as shown in Table 1. The copyright information in Table 1 prescribes for each of two copying methods (printing and data copying) whether copying is permitted or forbidden (including the duration of permission) and the fee. When copyright information in Table 1 has been acquired, a notice such as the one shown in FIG. 6 is displayed on the screen of the manipulation/display panel 14. FIG. 6 shows a case in which “printing” is selected as the copying method. It is of course possible to select “data copying” as the copying method and have it similarly displayed.

TABLE 1

| | | Printing | | Data copying | | Alternative |
|---|---|---|---|---|---|---|
| Area | Position | Yes/No | Fee | Yes/No | Fee | information |
| A | — | Yes | $0.2 | Yes | $2 | |
| B | — | Yes | $0.08 | Yes | $0.8 | |
| C | — | Yes until end | $0.5 | Yes until end | $5 | |
| | | of Sept. | | of Sept. | | |
| D | — | No | — | No | — | Copying of |
| | | | | | | photo |
| | | | | | | forbidden |
| E | — | Yes | $0 | Yes | $0 | |

Thus, copyright information on each area of the image of the document 50 shown in FIG. 5 is schematically represented. The screen of FIG. 6 shows the copyright fee for the printing of any of the areas A through D whose utilization is restricted by a copyright (hereinafter sometimes called “copyrighted area”). Or if an area is forbidden from printing, there is a statement to that effect. Area E whose utilization is not restricted by a copyright is indicated as a free area.

Further at the bottom of the frame, “Basic Fee”, which is the basic charge for print outputting by the multifunctional copying machine 1 and “Copying Fee”, which is the total of the copyright fee for all the areas currently selected, are also displayed. If the document 50 covers a plurality of pages, “Total Sum”, which also includes the fees for other pages and “Deposited Sum”, which is the sum of money put into the coin dispenser 16 by the current moment, are also displayed. In addition to them, the sum required for copying all the copyrighted areas in the document 50 may also be displayed. It is also conceivable to enable the user to recognize the areas selectable within the “Deposited Sum” by changing the display color or otherwise.

On the screen of FIG. 6, the user can select the desired copyrighted area or cancel the selection of the area by touching that area. The contour of any area that is not selected is expressed in broken lines. A print-forbidden area, such as area D, cannot be selected. A free area, such as area E, is always in a selected state. Of course, it is possible to allow the user to cancel the selection of the free area by his or her manipulation. When the selected state of areas is altered by the user's manipulation, the sum of “Copying Fee” at the bottom left also is altered accordingly. FIG. 6 shows a state in which all the areas but the unselectable area D are selected. Thus, the user can make selection while visually confirming information on the fee for each area and other items.

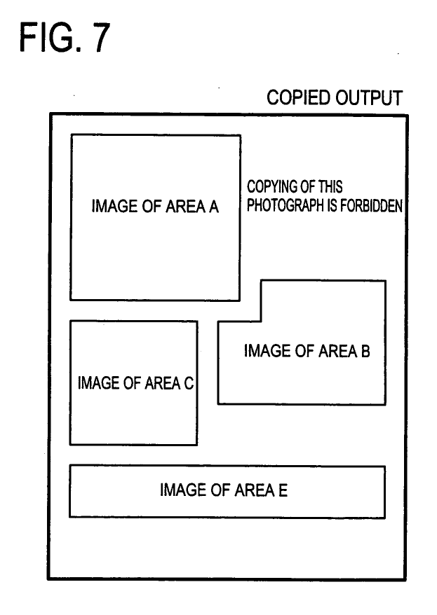

Hereupon, if the “Deposited Sum” is not smaller than the “Copying Fee”, printing can be executed. When printing is executed in the selection state of FIG. 6, a copied output shown in FIG. 7 is obtained. Thus the image of the unprintable area D is not reproduced, but those of all other areas are reproduced. Of course, the displayed sums in the right hand part and in the bottom part of FIG. 6 are not printed.

In FIG. 7, what is made available as “Alternative information” in Table 1 is arranged in the position of area D in place of the image which should be there. This enables the user having seen the copied output to know the reason for the absence of the image which could be there. Other possible ways of processing the area from which the image has been deleted include leaving the part entirely blank, painting is solidly with a specific color, showing only the contour, and showing only the type of the original image (photograph, character information, or some other distinguishing information). As the alternative information, besides what is ready in the IC chip 51, something made available in advance in the multifunctional copying machine 1 can be used as well.

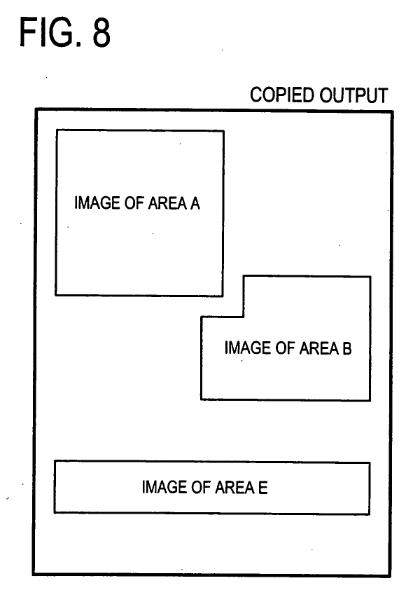

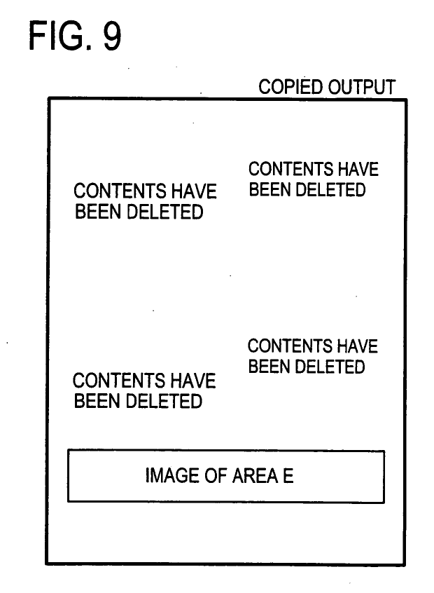

FIG. 8 shows an example of output which is provided when printing has been executed with area C whose copyright fee is high in FIG. 6 being deleted. Specifically, FIG. 8 shows a case of output which is provided when printing has been executed with a total blank being used for processing the areas whose images have been deleted. Another example of output is shown in FIG. 9, which is provided when printing has been executed with the selection of all the areas but free area E in FIG. 6 being canceled. The fee to be paid in this case is only the “Basic Fee”. Specifically, FIG. 9 shows a case of output in which “Contents have been deleted”, which is alternative information made ready in advance in the multifunctional copying machine 1, is arranged as processing of the areas from which images have been deleted.

To add, only a one-page equivalent of information is displayed in the case shown in FIG. 6. However, if the document 50 comprises a plurality of pages, information equivalent to that plurality of pages may be displayed as well. Further, instead of allowing merely the selection or non-selection of each individual area for copying, an editing function to gather areas to be copied and composing them into a new page may be provided as well. Alternatively, a selection screen such as the one shown in FIG. 6 may be displayed on the display unit of the server 3 or the PC 4 via a network to allow manipulations for selection to be accepted on that screen.

In the description hitherto made, it was supposed that copyright information on any image would be acquired from the IC chip 51. However, this is not the only available method, but it can as well be acquired from the copyright information server 2 via the network shown in FIG. 1. In this case, it is sufficient for the IC chip 51 to record only the ID code of the document 50 or the ID code of the image of each area. In the copyright information server 2 such information items as those listed in Table 1 are recorded, matched with the ID code of the document 50. Or else, matched with the ID code of the image of each area, such information items as those in the “Position”, “Printing, Yes/No”, “Fee” and “Alternative information” in Table 1 are recorded. Further, copyright information can as well be acquired from both the IC chip 51 and the copyright information server 2. In this way, whether the copyright information in the IC chip 51 is altered or not can be confirmed.

Alternatively, the ID code of the document 50 or the image of each area can be recorded as a bar code or a two-dimensional code somewhere on the face of the document 50. In this case, no IC chip 51 would be required. Furthermore, where these codes have large data recording capacities, copyright information itself can be encoded and recorded in this form. In this case, there would be no need even to access the copyright information server 2.

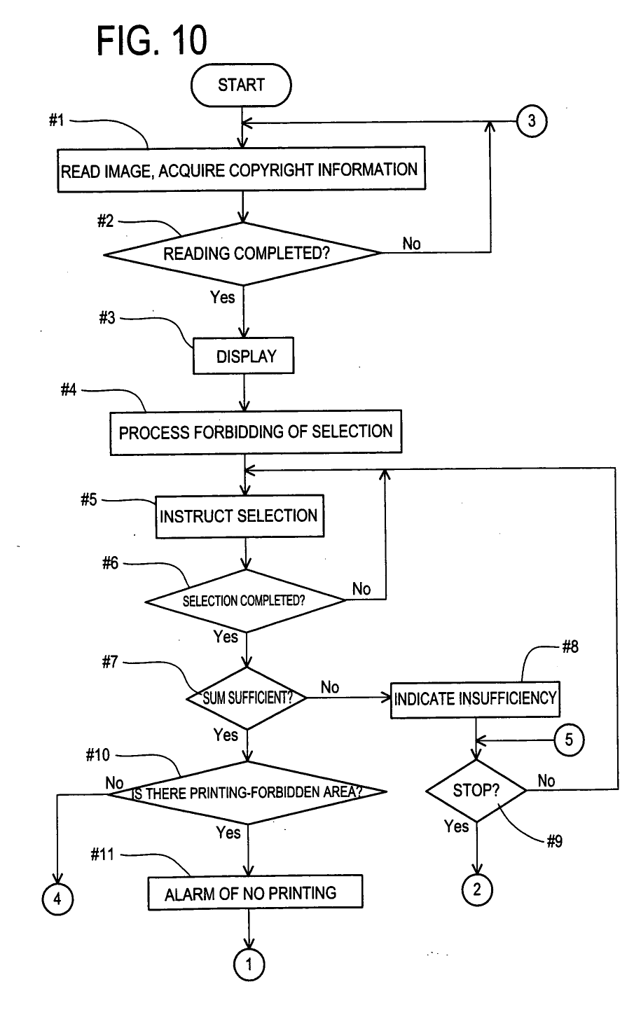

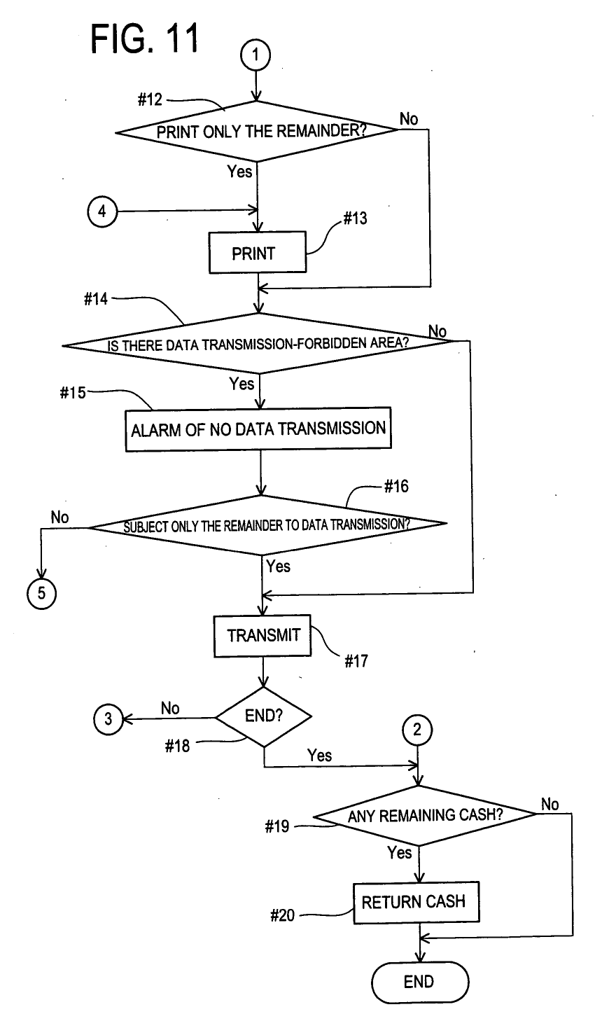

Details of copying operation in this case of processing by the multifunctional copying machine 1 will be described with reference to flow charts of FIG. 10 and FIG. 11. In the description of these flow charts, both printing and data copying are supposed to be performed as copying methods. The destination of a copy by data copying is the PC 4 shown in FIG. 1. In the description of this flow, data copying will be referred to as “data transmission”. When the user sets a document 50 equipped with an IC chip 51 on the scanner 11 and enters a start instruction, this flow is started. During the execution of this flow, the coin dispenser 16 accepts cash put into it any time as a rule.

At the beginning of this flow, the slider 20 reads the image of the document 50. At the same time, communication by the antenna 21 with the IC chip 51 also takes place. In this way, copyright information concerning the image of the document 50 is acquired from the IC chip 51 (#1). Of course, the copyright information may be acquired by some other method as described above. Upon completion of reading the document 50 and acquisition of the copyright information (#2: Yes), displaying based on the acquired copyright information is accomplished on the manipulation/display panel 14 (#3). This causes a screen as illustrated in FIG. 6 to be displayed. As described, the areas to be copied are selected on this display screen.

For this purpose, first, forbidding of selection is processed (#4). That is, areas of which both “printing” and “data copying” are forbidden by the copyright information are made unselectable by the user in advance. In this context, any area of which copying is permitted for a limited period of time is regarded as forbidden from being copied, if the current time is not within this period. Then, the user's selection is accepted (#5). If here the user tries to select any area whose selection was forbidden at #4, some kind of reminder may be given to him or her. Or if an area of which only one of printing and data transmission is permitted, a reminder may also be given.

When the user presses an OK button 49 in FIG. 6, the area selection is deemed to have been completed (#6: Yes), and it is judged whether or not a sufficient copying fee has been paid (#7). This judgment is made by comparing the required copying fee and the sum currently deposited in the coin dispenser 16. Namely, the sum deposited in the coin dispenser 16 is the upper limit. The required copying fee is the sum of the total copyright fee for the areas selected at the time and the basic copying fee.

If the sum deposited is insufficient for the required sum (#7: No), the message of the insufficiency will be displayed on the manipulation/display panel 14 (#8). This situation can be coped with by one of three options, stop of copying, a reduction of the selected areas, and additional depositing of money. As a matter of flow, it is determined whether or not to stop first (#9). When the user enters a stop instruction (#9: Yes), the processing goes ahead to #19 to be described afterwards (FIG. 11). If the user opts for continued processing (#9: No), the processing will return to #5 and #6 for area selection. Hereupon, the user can reduce the selection of areas or can deposit an additional sum into the coin dispenser 16. If the deposited sum is not less than the required sum when the OK button 49 is pressed again, the judgment of #7 will be “Yes”, and processing of printing will be followed.

First in the processing of printing, it is judged whether or not there is an area whose printing is forbidden (#10). This is because any area which permits only data transmission may have been selected. If any area whose printing is forbidden has been selected (#10: Yes), an alarm of no printing will be issued (#11). And the user will be asked whether or not to print the remainder, namely only the areas whose printing is permitted (#12; the following is covered by FIG. 11). If the user opts for “printing” (#12: Yes), printing will be executed (#13). In this case, out of the selected areas, only those whose printing is permitted are printed. The unselected or printing-forbidden areas are either left blank or replaced with alternative information.

If at #12 the user opts for “not printing” (#12: No), #13 will be bypassed to proceed to data transmission. Unless any area whose printing is forbidden was selected at #10 (#10: No), #11 and #12 will be bypassed to execute printing (#13). In this case, the selected areas are printed. The unselected areas are either left blank or replaced with alternative information. In this way, the copied outputs illustrated in FIG. 7 through FIG. 9 are obtained.

When printing has been executed at #13, an equivalent of the total fee required for the printing is accepted out of the sum deposited in the coin dispenser 16. A corresponding subtraction is made from the effective balance of the deposited sum. At the same time, information that the printing has been executed is transmitted from the macro-system controller 19 to the copyright information server 2. This enables the copyright fee pertaining to the printing to be appropriately distributed to the right holders concerned. Incidentally, where printing paper sheets in which memory elements such as IC chips are embedded are to be used, it is also possible to write copyright information into those memory elements. Then, the processing of data transmission follows.

First in the processing of data transmission, it is judged whether or not there is any area whose data transmission is forbidden (#14), because any area which permits only printing may have been selected. If any area whose data transmission is forbidden is selected (#14: Yes), an alarm of no data transmission will be issued (#15). And the user will be asked whether or not to subject the remainder to data transmission, namely only the areas whose data transmission is permitted (#16). If the user opts for “data transmission” (#16: Yes), data transmission will be executed (#17). In this case, out of the selected areas, only those whose data transmission is permitted are subjected to data transmission. The unselected areas or data transmission-forbidden areas are either left blank or replaced with alternative information.

If at #16 the user opts for “no data transmission” (#16: No), the processing 13 will return to #9 in FIG. 10. Unless any area whose data transmission is forbidden was selected at #14 (#14: No), #15 and #16 will be bypassed to execute data transmission (#17). In this case, the selected areas are subjected to data transmission. The unselected areas are either left blank or replaced with alternative information. When the image data are transmitted to the PC 4 in this way, the PC 4 can display the pertinent image on the screen. Incidentally, not only the image data but also the pertinent copyright information may also be transmitted at the time of data transmission.

When data transmission has been executed at #17, an equivalent of the total fee required for the data transmission is accepted out of the sum deposited in the coin dispenser 16. A corresponding subtraction is made from the effective balance of the deposited sum. At the same time, information that the data transmission has been executed is transmitted from the macro-system controller 19 to the copyright information server 2. This enables the copyright fee pertaining to the data transmission to be appropriately distributed to the right holders concerned.

When data transmission has been executed, the user will be asked whether or not to end the processing (#18). If it is not to be ended (#18: No), the processing will return to #1 in FIG. 10 to perform similar processing on the succeeding document 50 as well. If it is to be ended (#18: Yes), it will be determined whether or not there is any remaining cash in the coin dispenser 16 (#19). If there remains any cash (#19: Yes), it will be returned (#20). When the remaining cash is returned, this processing is ended.

In this case of processing, it is possible to decide in this way for each area whether to copy or not. Therefore, the user is enabled to select the area or areas to be copied while taking into account the sum of the copyright fee.

In the foregoing description of the flow charted in FIGS. 10 and 11, it was supposed that both printing and data copying were available as copying methods. For this reason, only the areas of which neither “printing” nor “data copying” was allowed were forbidden from selection at #4. However, in actual practice, there can be cases where only one of the two copying methods may be executed. In such a case, judgment at #4 can be made only about the applicable method of copying. Further in this flow, a selection for which the required sum surpasses the “Deposited Sum” is tentatively accepted, and whether or not it is sufficient is judged at #7. However, this is not the only possible way, but any selection for which the required sum surpasses the “Deposited Sum” is refused immediately.

Further in the processing of selection at #5 and #6, when the user attempts to select any area for which one of the copying methods is forbidden but the other is not, a message to the effect that only the other copying method is allowed can be displayed. In this case, the steps #10 through #12 and #14 through #16 of processing are unnecessary, because no forbidden area is selected. And of course, only the applicable one of printing (#13) and data transmission (#17) can be executed.

[Second Case of Processing]

As a second case of processing by the multifunctional copying machine 1, a case in which copyright fee information differing with the printing conditions is set for each area of the image of the document 50 and the printing conditions are selected for each area will be described. The printing conditions include, for instance, the magnifying rate, picture quality (such as the number of pixels, the number of gray levels, the accuracy of color correction, shading off and mosaicking), the number of colors and the presence or absence of coating. In this case of processing, the method of copying itself is supposed to be printing.

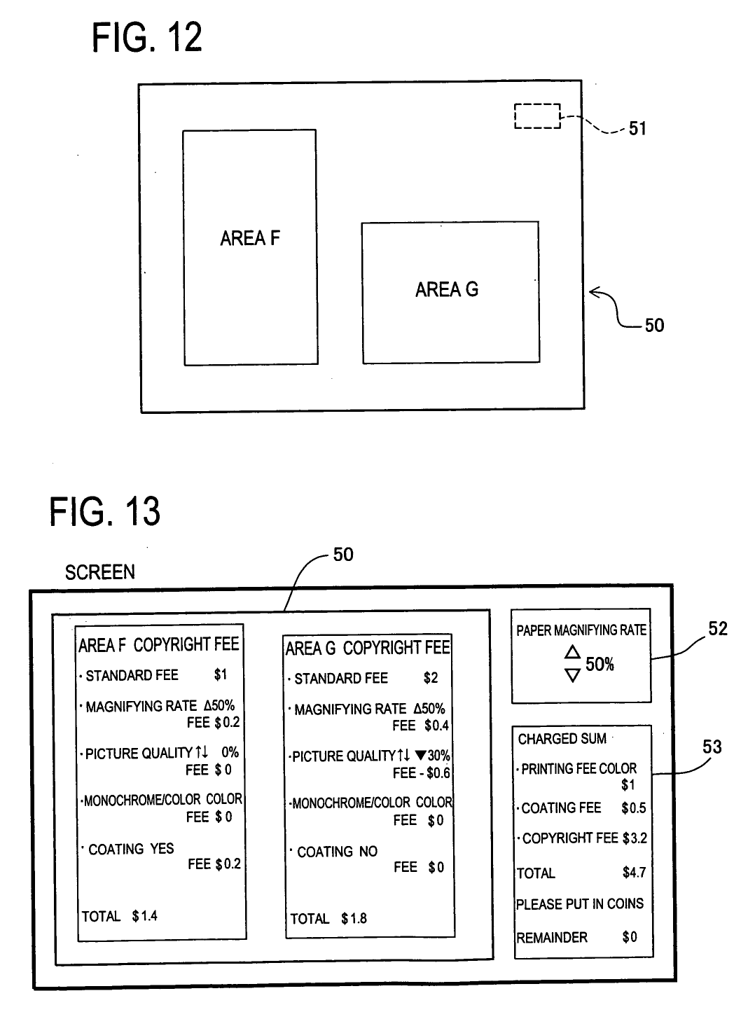

For instance, the image of the document 50 is supposed to be like what is shown in FIG. 12. In the example of FIG. 12, there are areas F and G in a page. Copyright information of the IC chip 51 in this case is shown in Table 2. In the copyright information in Table 2, the sums to be added or subtracted when changing the printing conditions are shown in addition to the standard fees. Accordingly, a display shown in FIG. 13 is given on the screen of the manipulation/display panel 14.

TABLE 2

| | | | Magnifying/ | | | Picture | | | |
|---|---|---|---|---|---|---|---|---|---|
| | | Standard | reducing fee | | | quality fee | | Monochrome | |
| Area | Position | fee | +50% | — | −50% | — | −30% | fee | Coating fee |
| F | — | $1 | $0.2 | — | −$0.2 | — | — | −$0.3 | $0.2 |
| G | — | $2 | $0.4 | — | −$0.4 | — | −$0.6 | −$0.3 | $0.4 |

The screen of FIG. 13 includes the schematic representation of the document 50 in FIG. 12, a paper magnifying rate selecting unit 52 and a sum display unit 53. The user can alter the magnifying rate of the whole image by touching a triangular mark in the paper magnifying rate selecting unit 52 in this screen with a finger. Interlocked with this alteration, the magnifying rate of each area is also altered. The user can also alter the printing conditions of each area by touching with a finger any desired position in the schematically representing part of the document 50. There can be cases where magnifying rate of each area can also be altered individually. In the sum display unit 53, the required fee under the current printing conditions and the sum currently deposited in the coin dispenser 16 are displayed. The “coating fee” in the required sum corresponds to the charge for the use of the multifunctional copying machine 1 in coating the formed image. Differentiated from this, the fee for “Coating” in each individual area means the fee to be added to the copyright fee for having the image coated.

Hereupon, if the “Remaining money” in the sum display unit 53 is not less than the “Total” μm, printing can be executed. When printing is executed under the printing conditions shown in FIG. 13, a copied output magnified to 1.5 times the size of the original document is obtained. In that copied output, the images of both areas F and G are magnified 1.5 times. The image of area F is coated, and that of area G is degraded in picture quality by 30%.

The processing flow of the copying operation in this case of processing by the multifunctional copying machine 1 is substantially the same as the flow charted in FIG. 10 and FIG. 11. A difference lies, however, in that selections at #5 and #6 include the selection of printing conditions for each area. Incidentally, indication of “Please put in coins” in the sum display unit 53 in FIG. 13 is one example of realization of insufficient indication at #8. Information to be transmitted to the copyright information server 2 on the occasion of printing at #13 includes information of the printing conditions executed. Further, since the absence of any printing-forbidden area is supposed in this case of processing, judgment at #10 is always “No”, and neither #11 nor #12 is executed. At #13, image formation and post-treatment are carried out in accordance with the printing conditions for each area. As the absence of data transmission is supposed in this case of processing, none of #14 through #17 is executed. It is of course possible to perform data transmission in this case of processing.

In this way, the printing conditions can be selected for each area in this case of processing. Therefore, the user is enabled to select the printing conditions for each area to be copied while taking into account the sum of the copyright fee.

[Third Case of Processing]

Next, a third case of processing by the multifunctional copying machine 1 will be described. This case of processing is basically the same as the second case of processing. Especially, the magnifying rate can be individually altered for each area in this processing also. But a difference lies in that any overlapping of areas that may occur as a result can be appropriately coped with in this processing. In this case of processing, the method of copying itself is supposed to be printing.

This case of processing is significant when the magnifying rate is raised for each area without enlarging the paper size in the display screen of FIG. 13, because in such a case image areas may overlap each other.

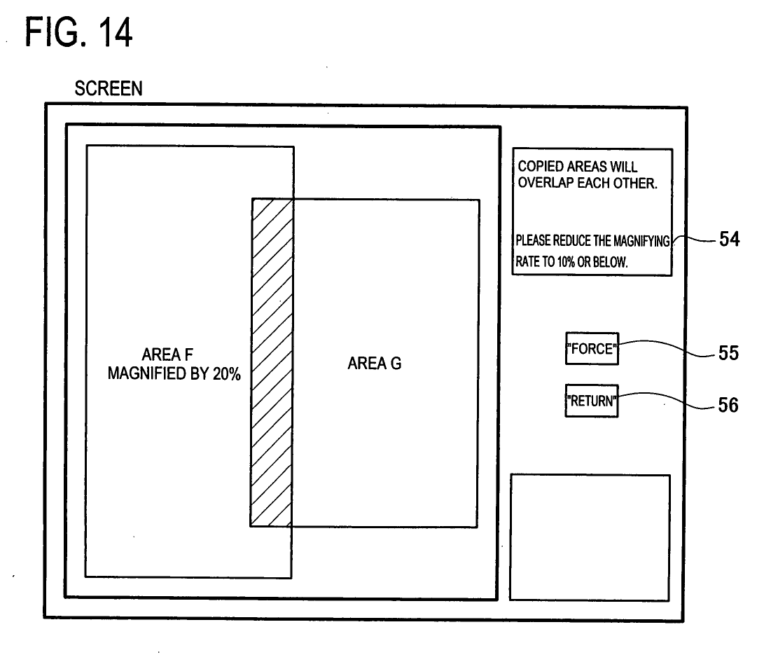

It is supposed, for instance, that a condition of magnifying only area F by 20% at a paper magnifying rate of 0%, namely while keeping the same paper size in the display screen of FIG. 13. If in this case area F and area G overlap each other, the screen of FIG. 14 will be displayed on the manipulation/display panel 14. This screen illustrates the overlapping of area F and area G. A message 54 to recommend a reduction of the magnifying rate to eliminate overlapping is also displayed. This is intended to arouse the attention of the user. Further, a “Force” button 55 and a “Return” button 56 are also displayed. The “Force” button 55 is an instruction button intended for use by a user who does not care about overlapping and wants outputting the copy as it is. This makes it possible to pay respect to the user's intention. The “Return” button 56 is intended for return to the selection screen of FIG. 13.

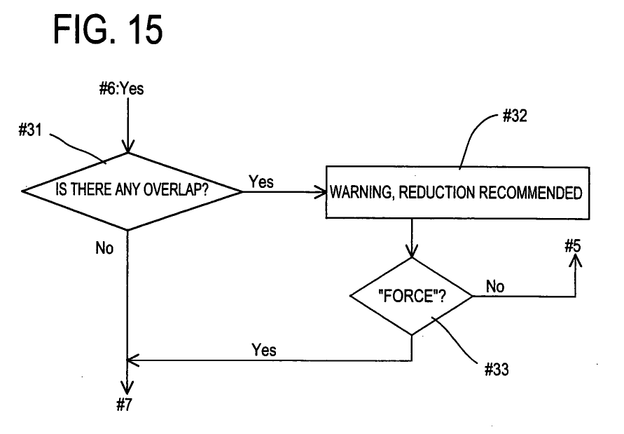

The processing flow of the copying operation in this case of processing by the multifunctional copying machine 1 differs from the flow charted in FIG. 10 and FIG. 11 in that #31 through #33 shown in FIG. 15 are inserted between (#6: Yes) and #7 in the flow chart of FIG. 10. That is, upon completion of the selection of the area and the printing conditions by the user (#6: Yes), the presence or absence of any overlap is judged (#31). It is judged whether or not the situation illustrated in FIG. 14 is present. If there is no overlap (#31: No), the sequence returns to FIG. 10 to process the steps of #7 onward. If there is any overlap (#31: Yes), that fact is warned against and a reduction is recommended (#32). This is what is meant by the message 54 in FIG. 14. The “Force” button 55 is also displayed then.

Then it is judged whether or not to force printing under the current conditions (#33). This judgment takes effect according to which of the “Force” button 55 and the “Return” button 56 in FIG. 14 is pressed first. If the “Force” button 55 is pressed first, #33 is judged “Yes”. For this reason, the sequence returns to FIG. 10 and processing from #7 onward is executed as it is. Thus, the user's selection is respected, and printing is executed with the overlap of areas being left as it is. If the “Return” button 56 is pressed first, #33 is judged “No”. For this reason, the sequence returns to #5 of FIG. 10. As a result, the selection screen of FIG. 13 is displayed again. The user can then alter his or her selection of the area and the printing conditions.

Thus in this case of processing, appropriate selection of printing conditions can be supported so as to avoid mutual overlapping of images. Incidentally, similar processing can be applied against the jutting of an image out of the printable area in addition to the mutual overlapping of images. Further, similar processing can be applied not only when the magnifying rate of an area has been altered but also when the positions in which areas are arranged within the paper have been altered. The same applies when the editing function is used.

[Fourth Case of Processing]

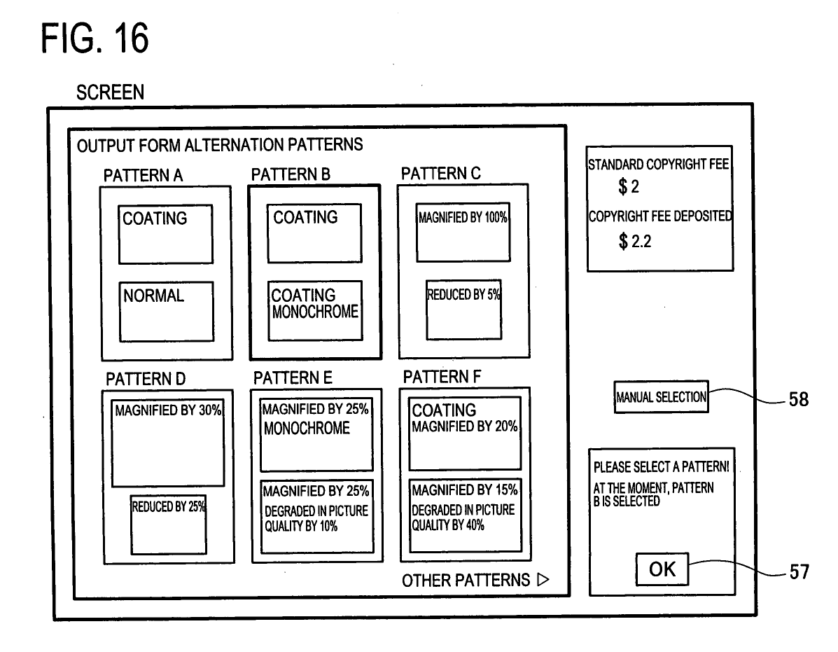

Next, a fourth case of processing by the multifunctional copying machine 1 will be described. This case of processing is another developed form of the second case of processing. It is a case of processing in which the selection of printing conditions at #5 and #6 in FIG. 10 is supported. For this purpose, when the user selects the area and the printing conditions, standard patterns of selection are presented in this case of processing. The user can make his or her selection out of the presented patterns. For this reason, after the document 50 has been read, the display of FIG. 16 is given on the manipulation/display panel 14 in place of that of FIG. 13.

The screen of FIG. 16 has a space for “output form alternation patterns”, in which a plurality of output patterns are illustrated. The output patterns shown in FIG. 16 constitute cases in which the original document 50 has two areas, upper and lower. For instance, “Pattern A” is a pattern of which the upper area is copied together with coating and the lower area is normally copied. “Pattern B” is a pattern of which both upper and lower areas are coated and the lower area is copied monochromically. “Pattern C” is a pattern of which the upper area is magnified by 10% and the lower area is reduced by 5%. “Pattern D” is a pattern of which the upper area is magnified by 30% and the lower area is reduced by 25%. “Pattern E” is a pattern of which both upper and lower areas are enlarged by 25%, the image in the upper area is copied monochromically, and the picture quality of the lower area is degraded by 10%. “Pattern F” is a pattern of which the upper area is magnified by 20% together with coating and the lower area is degraded in picture quality by 40% while being magnified by 15%.

Every output pattern illustrated here is set for an image in a certain page in the original document 50. However, not just such patterns, but output patterns which bring together into a single page images extending over a plurality of pages, picked out and put together into a single may also be set.

On the screen of FIG. 16, the user can select a pattern by touching a desired one out of the presented patters in the “Output form alternation patterns” space. The contour of the selected pattern is represented in bold lines. Of course, the required fee for the selected pattern is indicated in the fee space at the top right of the screen. When an area is selected, an OK button 57 is displayed at the bottom right of the screen, and the selection is finalized by pressing this button. In this case, copying is executed according to the selected pattern. Or by pressing a manual selection button 58 near the right side of the screen, a shift to the selection screen of the mode shown in FIG. 13 can be accomplished. This also makes possible individual selection of whether or not to copy each area and the printing conditions.

The selection patterns presented here to the user may be either what have been set for that document 50 on the part of the right holder or general-purpose ones made available in advance in the multifunctional copying machine 1. In the former case, the pertinent data are stored in the IC chip 51 of the document 50 or in the copyright information server 2. In the latter case, the data of the selection patterns are stored in the macro-system controller 19 of the multifunctional copying machine 1, out of which the data that correspond to the arrangement of areas in and copyright information on the document 50 are used. The fee in that case is calculated from the copying conditions prescribed for each pattern and the copyright fee acquired from the IC chip 51.

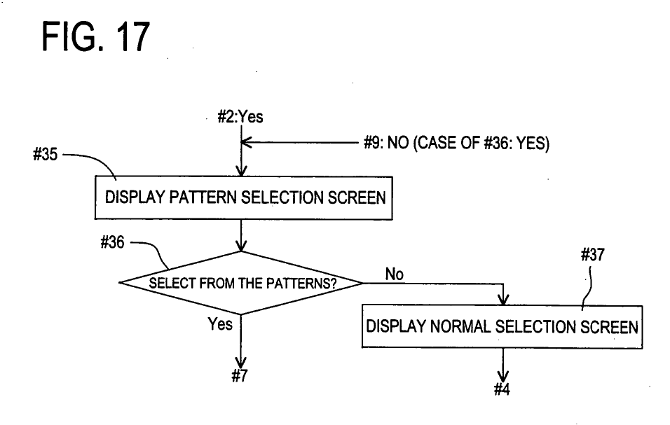

In the processing flow of the copying operation in this case of processing by the multifunctional copying machine 1, if there are data of selection patterns stored in the IC chip 51, they are also read at #1 of the flow chart of FIG. 10 and FIG. 11. After the end of reading, the processing shifts to #35 of FIG. 17 in place of #3, and a screen to have the patterns for selection shown in FIG. 16 is displayed. When the user having selected a pattern presses the OK button 57, #36 is judged “Yes”. In this case, the processing from #7 in FIG. 10 onward is executed according to the selected pattern. However, if a shortage of the sum invites judgment of (#9: No), the return destination is #35. When the user presses the manual selection button in the screen of FIG. 16, #36 is judged “No”. In this case, a shift to the normal selection screen as shown in FIG. 13 takes place (#37), and the processing from #4 onward in FIG. 10 is executed.

In this way in this case of processing, the complication of individually selecting printing conditions for each copyrighted area is eased. It is also possible to induce copying to be done in the pattern preferred by the right holder. To add, in this case of processing, it is also permissible for the user to tentatively select a proposed standard pattern and to shift to a manual selection mode from that pattern as the initial state.

As hitherto described in detail, when reading the image of the document 50, the multifunctional copying machine 1 in the present embodiment acquires the copyright information thereon as well. Then, in accordance with limitation to use regarding each individual area in the image, the user is enabled to appropriately select whether or not to copy and the conditions of copying, and to know the required fee. Further, selection of any area whose copying is forbidden is prohibited. This enables the user to avoid making wasteful selecting operations. Moreover, regarding unselected areas, alternative information is arranged. This enables anybody having seen the copied output to understand the circumstances.

Furthermore, when magnifying an area may invite overlapping of images or jutting-out of an image beyond the limit, a prior warning is given. This prevents the user from making an unintended output. Also, by offering standard selection patterns, the convenience of the user in the selection of copying conditions is enhanced. In this way, the multifunctional copying machine 1 which enables the user to select appropriate processing according to differences in copyright information in each area of the images and to achieve formation of an image is realized. There is also realized an image formation system configured of the multifunctional copying machine 1, the image formation system server 2 and so forth.

Incidentally, the present embodiment is only illustrative, but is nothing to limit the scope of the present invention. Therefore, the invention permits various improvements and modifications without deviating from its true spirit. For instance, the intellectual property right on which the restraint on reproduction is based is not limited to copyright. The restraint on reproduction may as well derive from other rights including design right and trademark right. The restraint on reproduction may also be set on information itself being looked upon as a valuable matter.

Further, though the coin dispenser 16 is used here as money collecting means, other electromagnetic account settlement means, such as a bank card, a credit card, a debit card or a prepaid card may be used as well. In this case, the judgment as to “μm sufficient?” at #7 in FIG. 10 can be made with reference to the credit line, the balance or a like factor of the card account. It is also possible to access information on the object account settlement means from a mobile communication terminal instead of using any of such cards.

Further, specific methods of data copying are not limited to data transmission to the server 3 or the PC 4. By providing a medium insertion slot in the multifunctional copying machine 1, the data can be copied onto a storage medium brought by the user. Copying by printing is not limited to printing by the multifunctional copying machine 1 itself. Where a printer, a facsimile machine, a DPE machine or the like is available on the network, a printing instruction can be transmitted to such a machine to have the printing done thereby.

It is desirable for the image copying device according to the invention to further have a display screen for displaying information regarding formation of images and accepting manipulation by the user on the displayed information, and a reproduction constraint information display unit which displays the reproduction constraint information acquired by the reproduction constraint information acquiring unit on the display screen on an area-by-area basis. In this way, the selection accepting unit is enabled to accept selections in response to manipulation on the display screen.

Or, the image copying device according to the invention may further have a transceiver unit for transmitting information regarding the formation of images and reproduction constraint information acquired by the reproduction constraint information acquiring unit to an external device for displaying thereon and receiving information on manipulation by the user from that external device. In this way, the selection accepting unit is enabled to accept selections in response to information on manipulation at the external device received via the transceiver unit.

It is preferable for the reproduction constraint information acquiring unit of the image copying device according to the invention to acquire reproduction constraint information on images from a storage medium embedded in the document. Or, the reproduction constraint information acquiring unit may as well acquire reproduction constraint information on images from an external information server.

It is even more preferable for the selection accepting unit of the image copying device according to the invention also to accept selection of copying conditions for each area within a limit permitted by the reproduction constraint information. In this case, it is desirable for the image copying device to have a required sum calculating unit for calculating the sum of the required fee for copying in the state of selection accepted by the selection accepting unit in accordance with the reproduction constraint information.

It is further desirable for the selection accepting unit of the image copying device according to the invention to forbid in advance manipulation to make selection which would select of an area whose reproduction constraint information is “copying forbidden”. It is also desirable for the unit to automatically select of copying of an area whose reproduction constraint information is “copying free”. It is further desirable for the reproduction constraint information display unit to display on its display screen the fact of an area whose reproduction constraint information is “copying free”. It is also desirable for the transceiver unit to have the fact of any area, whose reproduction constraint information is “copying free”, to be included in the display on the external device.

It is desirable for the image copying device according to the invention to further have an alternative information arranging unit for arranging alternative information in place of original image data with respect to an area for which “no copying” has been selected by the selection accepting unit or whose reproduction constraint information is “copying forbidden” at the time of copying by the copying unit. It is also desirable to have a total sum calculating unit which calculates the sum required for copying all the selectable areas.

It is also desirable for the image copying device according to the invention to have a charging device for collecting copying fees and a charging information transmitting unit for transmitting information on the copying fees to an external information server at the time of the execution of copying. This enables the selection accepting unit to refuse selection which would cause the required sum to surpass the upper limit in the charging device based on the reproduction constraint information.

It is also desirable for the image copying device according to the invention to have an alarming unit for warning the user when overlapping of images or jutting-out of an image beyond the printable size might occur in the state of selection accepted by the selection accepting unit. It is desirable, too, for the selection accepting unit to present prepared selection patterns to the user.

Incidentally, the copying unit in the image copying device according to the invention may perform copying in one or two ways including printing, by which an image based on image data is formed on a medium, and data copying, by which image data are copied onto a storage medium.

What is claimed is:

1. An image copying device for copying an image of a document, comprising:
a scanner for acquiring image data by scanning the document,
a reproduction constraint information acquiring unit for acquiring reproduction constraint information on the image of each area of the document,
a selection accepting unit for accepting selection by a user regarding whether or not copying is performed with respect to each area of the document within an extent permitted by the acquired reproduction constraint information, and
a copying unit for copying image pertaining to the area selected to be copied by the selection accepting unit based on the image data acquired by the scanner.

2. The image copying device according to claim 1, further comprising:
a display screen for displaying information regarding formation of images and accepting manipulation by the user on the displayed information; and
a reproduction constraint information display unit which displays the reproduction constraint information acquired by the reproduction constraint information acquiring unit on the display screen on an area-by-area basis,
wherein the selection accepting unit accepts selections in response to manipulation on the display screen.

3. The image copying device according to claim 1, further comprising:
a transceiver unit for transmitting information regarding the formation of images and reproduction constraint information acquired by the reproduction constraint information acquiring unit to an external device for displaying thereon and receiving information on manipulation by the user from that external device, wherein:
the selection accepting unit accepts selections in response to information on manipulation on the external device received via the transceiver unit.

4. The image copying device according to claim 1, wherein:
the reproduction constraint information acquiring unit acquires reproduction constraint information on images from a storage medium in the document.

5. The image copying device according to claim 1, wherein:
the reproduction constraint information acquiring unit acquires reproduction constraint information on images from an external information server.

6. The image copying device according to claim 1, wherein:
the selection accepting unit forbids in advance selective manipulation which would select copying of an area whose reproduction constraint information is “copying forbidden”.

7. The image copying device according to claim 1, wherein:
the selection accepting unit automatically selects copying of an area whose reproduction constraint information is “copying free”.

8. The image copying device according to claim 2, wherein:
the reproduction constraint information display unit displays, regarding an area whose reproduction constraint information is “copying free”, that fact on the display screen.

9. The image copying device according to claim 3, wherein:
the transceiver unit causes, regarding an area whose reproduction constraint information is “copying free”, that fact to be included in the display by the external device.

10. The image copying device according to claim 1, further comprising:
an alternative information arranging unit for arranging alternative information in place of original image data with respect to an area for which “no copying” has been selected by the selection accepting unit or whose reproduction constraint information is “copying forbidden” at the time of copying by the copying unit.

11. The image copying device according to claim 1, further comprising:
a required sum calculating unit for calculating the sum of a required fee for copying in the state of selection accepted by the selection accepting unit based on the reproduction constraint information.

12. The image copying device according to claim 1, further comprising:
a total sum calculating unit which calculates the sum required for copying all the selectable areas based on the reproduction constraint information.

13. The image copying device according to claim 1, further comprising:
a charging device for collecting copying fees, and
a charging information transmitting unit for transmitting information on the copying fees to an external information server at the time of execution of copying,
wherein the selection accepting unit refuses selection which would cause a required sum to surpass the upper limit in the charging device based on the reproduction constraint information.

14. The image copying device according to claim 1, wherein:
the copying unit performs printing, by which an image based on image data is formed on a medium, and data copying, by which image data are copied onto a storage medium.

15. The image copying device according to claim 1, wherein:
the selection accepting unit also accepts selection of copying conditions for each area within a limit permitted by the reproduction constraint information, and
the image copying device further comprises:
the required sum calculating unit for calculating the sum of the required fee for copying in the state of selection accepted by the selection accepting unit based on the reproduction constraint information.

16. The image copying device according to claim 15, further comprising:
an alarming unit for warning the user when duplication of images or jutting-out of an image beyond the printable size might occur in the state of selection of copying conditions accepted by the selection accepting unit.

17. The image copying device according to claim 15, wherein:
the accepting unit presents prepared selection patterns to the user.

18. An image copying system comprising an image copying device for copying an image of a document and a reproduction constraint information server in which reproduction constraint information on images is accumulated, wherein
the image copying device further comprises:
a scanner for acquiring image data by scanning the document,
a reproduction constraint information acquiring unit for acquiring reproduction constraint information on the image of each area of the document from the reproduction constraint information server,
a selection accepting unit for accepting selection by a user regarding whether or not copying is performed with respect to each area of the document within an extent permitted by the acquired reproduction constraint information, and
a copying unit for copying image pertaining to the area selected to be copied by the selection accepting unit based on the image data acquired by the scanner.

19. An image copying system comprising an image copying device for copying an image of a document, a charging device for collecting copying fees, and a reproduction constraint information server in which reproduction constraint information on images is accumulated, wherein
the image copying device further comprises:
a scanner for acquiring image data by scanning the document,
a reproduction constraint information acquiring unit for acquiring reproduction constraint information on the image of each area of the document,
a selection accepting unit for accepting selection by a user regarding whether or not copying is performed with respect to each area of the document within an extent permitted by the acquired reproduction constraint information,
a copying unit for copying image pertaining to the area selected to be copied by the selection accepting unit based on the image data acquired by the scanner, and
a charging information transmitting unit for transmitting information on the copying fees to the reproduction constraint information server at the time of the execution of copying.

20. An image copying method for copying an image of a document, comprising the steps of:
acquiring image data by scanning the document with a scanner,
acquiring reproduction constraint information on the image of each area of the document with a reproduction constraint information acquiring unit,
accepting selection by a user regarding whether or not copying is performed with respect to each area of the document within an extent permitted by the acquired reproduction constraint information, and
copying image pertaining to the area selected to be copied by the selection accepting step with a copying unit based on the image data acquired by the scanner.
